(19) United States
(12) Patent Application Publication
(10) Pub. No.: US 2015/0058532 A1
(43) Pub. Date: Feb. 26, 2015

(54) MEMORY DEVICE, INFORMATION-PROCESSING DEVICE AND INFORMATION-PROCESSING METHOD

(71) Applicant: Kabushiki Kaisha Toshiba, Minato-ku (JP)

(72) Inventors: Shigenori SUGIMOTO, Yokohama-shi (JP); Shoji SAWAMURA, Yokohama-shi (JP); Takaya HORIKI, Kawasaki-shi (JP); Daisuke IWAI, Yokohama-shi (JP)

(73) Assignee: Kabushiki Kaisha Toshiba, Minato-ku (JP)

(21) Appl. No.: 14/086,226

(22) Filed: Nov. 21, 2013

Related U.S. Application Data
(60) Provisional application No. 61/869,837, filed on Aug. 26, 2013.

(51) Int. Cl. G06F 3/06

(52) U.S. Cl. CPC G06F 3/0655; G06F 3/0679; G06F 3/0619
USPC 711/103

(57) ABSTRACT

A memory device of an embodiment includes a non-volatile storage device, and a volatile storage device that stores observation information indicating a state of the memory device. The memory device is provided with a controller that executes an observation information sending process that sends a write command, which is an instruction to write the observation information in the host-side storage device, and the observation information to the host device. Further, the controller repeats the observation information sending process plural times in response to one sending request from the host device.

### CROSS-REFERENCE TO RELATED APPLICATIONS

This application is based upon and claims the benefit of priority from U.S. Provisional Application No. 61/869,837), filed on Aug. 26, 2013; the entire contents of which are incorporated herein by reference.

### FIELD

Embodiments described herein relate generally to a memory device, an information processing device, and an information processing method.

### BACKGROUND

In a GPU (Graphical Processing Unit) and the like in which a plurality of arithmetic processors is integrated, a technique called UMA (Unified Memory Architecture) that shares one memory among a CPU (Central Processing Unit) and the arithmetic processors instead of using dedicated memories is used. In a UFS (Universal Flash Storage) that is a memory device standard also has Unified Memory Extension defined therein as a similar technique.

In a memory device, in a case of observing internal management information from outside, the observation is carried out by a host-side issuing some type of command, and the memory device responding to this command. In employing this method, a load is casted on processing on a memory device-side.

Due to this, it is desired to suppress the load applied to the memory device while observing the management information from outside.

### BRIEF DESCRIPTION OF THE DRAWINGS

FIG. 1 is a drawing schematically illustrating a basic configuration of an information processing device of an embodiment;

FIG. 2 is a drawing illustrating an operation of a memory device sending management information to a host device; and

FIG. 3 is a diagram for explaining a write process of the management information and normal data from the memory device to the host device.

### DETAILED DESCRIPTION

According to an embodiment, a memory device is provided. The memory device is connected to a host device including a host-side storage device. The memory device includes a non-volatile storage device with which read and write of data is performed in accordance with a request from the host device. Further, the memory device includes a volatile storage device that stores information indicating a state of the memory device and to be observed by the host device as observation information. Further, the memory device includes a controller that executes an observation information sending process of sending a write command, which is an instruction to write the observation information in the host-side storage device, and the observation information to the host device. Further, the controller repeats the observation information sending process plural times for each incident of the observation information sending process without receiving an instruction to send the write command and the observation information from the host device.

Hereinbelow, a memory device, an information processing device and an information processing method of embodiments will be described in detail with reference to the attached drawings. Note that these embodiments do not limit the present invention.

### EMBODIMENTS

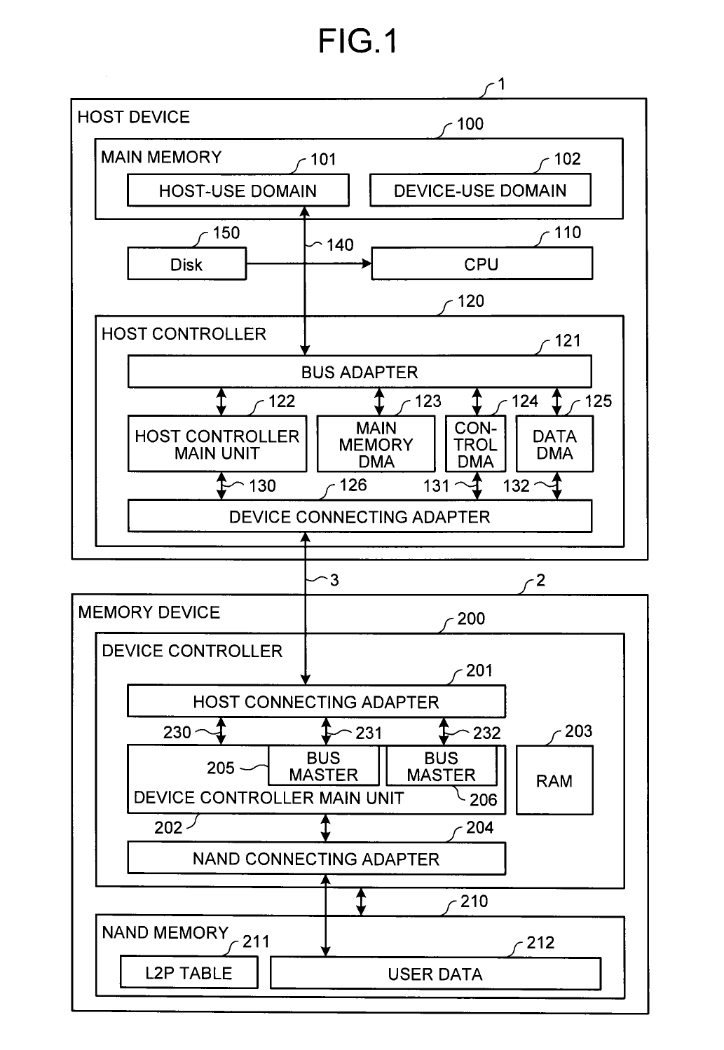

FIG. 1 is a drawing schematically illustrating a basic configuration of an information processing device of an embodiment. The information processing device of the embodiment includes a host device (external device) 1, and a memory device (memory system) 2 that functions as an external storage device of the host device 1. The information processing device is a UMA (Unified Memory Architecture), and a memory provided in the host device 1 (main memory 100 to be described later) is shared by the host device 1 and the memory device 2.

The memory device 2 of the embodiment spontaneously transfers management information to the host device 1. The management information that the memory device 2 transfers is information indicating a state of the memory device 2, and is information observed by the host device 1 (observation information). The management information is for example information for managing pages and blocks, information related to occurrences and corrections of errors, state variables of a firmware and the like.

The host device 1 and the memory device 2 are connected by a communication path 3. Flash memory, an SSD (Solid State Drive) and the like aimed for an embedded use in conformity to a UFS (Universal Flash Storage) standard can be adapted as the memory device 2. The information processing device is for example a personal computer, a cell phone, an imaging device and the like. As a communication standard of the communication path 3, for example MIPI (Mobile Industry Processor Interface) and UniPro are employed.

<Outline of Memory Device>

The memory device 2 includes NAND flash memory (NAND memory 210) that is an example of a non-volatile storage device (non-volatile semiconductor memory and the like), and a controller (device controller 200) that performs data transfer with the host device 1.

The NAND memory 210 is configured of one or more memory chips, each of which includes a memory cell array. The memory cell array is configured by a plurality of memory cells being arranged in a matrix. Further, each block in the memory cell array is configured of a plurality of pages. Each page is a unit of data reading and writing.

The NAND memory 210 stores an L2P table 211, and user data 212 sent from the host device 1. The user data 212 for example includes an operating system program (OS) for which the host device 1 provides an executing environment, a user program that the host device 1 executes in the OS, data that the OS or the user program inputs and outputs and the like.

The L2P table 211 is one of information that is necessary for the memory device 2 to function as the external storage device for the host device 1. The L2P table 211 is address conversion information that associates a logical block address (LBA) that the host device 1 uses upon accessing the memory device 2 and a physical address (block address+page address+in-page storage position) in the NAND memory 210.

The device controller 200 includes a host connecting adapter 201 that is a connecting interface with the communication path 3, and a NAND connecting adapter 204 that is a connecting interface with the NAND memory 210. Further, the device controller 200 includes a device controller main unit 202 that executes control of the device controller 200, and RAM (Random Access Memory) 203 that is a volatile storage device.

The RAM 203 is used as a buffer for storing data to be written to the NAND memory 210 or data read from the NAND memory 210. Further, the RAM 203 is used as a command queue that queues a command related to a write request, a read request, an instruction designating a type of the management information that is inputted from the host device 1. Further, the RAM 203 stores the management information of the memory device 2. For example, the RAM 203 can be configured of a small-scale SRAM or DRAM, and the like. Further, a resister and the like may substitute the function of the RAM 203.

The device controller main unit 202 controls the data transfer between the host device 1 and the RAM 203 via the host connecting adapter 201. Further, the device controller main unit 202 controls the data transfer between the RAM 203 and the NAND memory 210 via the NAND connecting adapter 204.

Besides performing the data transfer by using a first port 230 by functioning as a bus master in the communication path 3 with the host device 1, the device controller main unit 202 further includes two other bus masters 205, 206.

The bus master 205 can perform the data transfer with the host device 1 by using a second port 231. Further, the bus master 206 can perform the data transfer with the host device 1 by using a third port 232.

The device controller main unit 202 is for example configured of a microcomputer unit including an arithmetic device and a storage device. The device controller main unit 202 realizes the function as the device controller main unit 202 by the arithmetic device executing the firmware predeterminedly stored in the storage device.

Notably, the storage device may be omitted from the device controller main unit 202, and the firmware may be stored in the NAND memory 210. Further, the device controller main unit 202 can be configured by using an ASIC.

Further, the memory device 2 of the embodiment for example assumes the flash memory aimed for the embedded use in conformity to the UFS (Universal Flash Storage) standard. Due to this, the commands and the like described below are for example conform to the standard of the UFS.

<Outline of Host Device>

The host device 1 includes a CPU 110 that executes the OS and the user program, the main memory (host-side storage device) 100, a host controller 120, and a Disk 150. The main memory 100, the CPU 110, the Disk 150, and the host controller 120 are connected to one another by a bus 140.

The main memory 100 is for example configured by DRAM. The main memory 100 includes a host-use domain 101 and a device-use domain 102. The host-use domain 101 is used as a program expansion domain upon when the host device 1 executes the OS and the user program, and as a work area upon executing a program expanded in the program expansion domain.

The device-use domain 102 is a data storage domain allotted for devices other than the host device 1 (memory device 2 and the like). The device-use domain 102 is used as a cache domain for the management information of the memory device 2, and the data on which the reading and writing are to be performed. The Disk 150 is a hard disk and the like, and stores the management information that can no longer be stored in the main memory 100.

The management information of the embodiment is data that the memory device 2 stores (information inside the device), and is data that the host device 1 uses upon managing the information processing device. In other words, the management information is data that is observed by the host device 1 among the data stored in the memory device 2. The management information is for example information for debugging, performance measurement results, error correction history and the like.

Specifically, the management information is one of (1) to (3) below.

(1) page management information and block management information

(2) error occurrence information, error correction information, and retry information

(3) state variables of the firmware disposed in the data domain of the memory device 2

The page management information is information for managing the pages in the NAND memory 210, and the block management information is information for managing the blocks in the NAND memory 210. In the page management information, numbers and positions of valid pages and numbers and positions of invalid pages are managed. Further, in the block management information, numbers and positions of valid blocks, numbers and positions of invalid blocks, a number of erasure for each block and the like are managed. The page is a minimum unit of reading and writing data in the NAND memory 210. Further, the block is a minimum unit of erasing data in the NAND memory 210.

The error occurrence information is information related to the error occurrence reported upon reading and writing data in the NAND memory 210. The error correction information is information indicating a number of the error correction. The retry information is information indicating a number of retry operation that was performed in an even where the error correction was impossible.

The state variables of the firmware disposed in the data domain of the memory device 2 are information indicating an operation state of the firmware. The state variables are variables, arrangement, structure and the like in the data domain that is fixedly arranged at a certain domain in the RAM 203. The state variables are arranged in the data domain mainly as global variables.

<Outline of Port>

Next, respective ports of the host device 1 and the memory device 2 of the embodiment will be described. Although the host device 1 and the memory device 2 of the embodiment are physically connected by a single line (communication path 3), they are connected by a plurality of access points called ports as shown below (referred also as CPorts).

The host controller 120 includes a bus adapter 121 that is a connecting interface of the bus 140, a device connecting adapter 126 that is a connecting interface of the communication path 3, and a host controller main unit 122.

The host controller main unit 122 performs transfer of data and commands between the main memory 100 and the CPU 110 via the bus adapter 121. Further, the host controller main unit 122 performs transfer of data (including commands) with the memory device 2 via the device connecting adapter 126.

The host controller main unit 122 is connected to the device connecting adapter 126 by a first port 130, and can perform transfer of data with the memory device 2 via the first port 130.

Further, the host controller 120 includes a main memory DMA 123, a control DMA 124, and a data DMA 125. The main memory DMA 123 performs DMA transfer between the host-use domain 101 and the device-use domain 102.

The control DMA 124 captures a command that the memory device 2 sends to access the device-use domain 102. Further, in the control DMA 124, the host controller main unit 122 sends status information related to the device-use domain 102 to the memory device 2. The control DMA 124 is connected to the device connecting adapter 126 by a second port 131, and can send and receive commands and status information with the memory device 2 via the second port 131.

The data DMA 125 performs DMA transfer between the device-use domain 102 and the memory device 2. The data DMA 125 is connected to the device connecting adapter 126 by a third port 132, and can send and receive data with the memory device 2 via the third port 132.

Notably, by the functions of the device connecting adapter 126 and the host connecting adapter 201, the first port 130 corresponds to the first port 230, the second port 131 corresponds to the second port 231, and the third port 132 corresponds to the third port 232, respectively.

Specifically, the device connecting adapter 126 sends contents sent to the memory device 2 via the first port 130 to the device controller main unit 202 via the first port 230. Further, the device connecting adapter 126 sends contents sent to the memory device 2 via the second port 131 to the device controller main unit 202 via the second port 231. Further, the device connecting adapter 126 sends contents sent to the memory device 2 via the third port 132 to the device controller main unit 202 via the third port 232.

Further, the device connecting adapter 126 sends contents sent to the host device 1 via the first port 230 to the host controller main unit 122 via the first port 130. Further, device connecting adapter 126 sends contents sent to the host device 1 via the second port 231 to the control DMA 124 via the second port 131. Further, device connecting adapter 126 sends contents sent to the host device 1 via the third port 232 to the data DMA 125 via the third port 132. The contents sent to the control DMA 124 and the data DMA 125 are sent to the host controller main unit 122 for example via the bus adapter 121.

Notably, each of the ports 130 to 132 may independently include an input/output buffer to be used for the communication with the memory device 2. The host controller main unit 122, the control DMA 124 and the data DMA 125 are connected to the memory device 2 by using separate input/output buffers. According to this configuration, the host controller 120 can independently execute each of the communication with the memory device 2 using the host controller main unit 122, the communication with the memory device 2 using the control DMA 124, and the communication with the memory device 2 using the data DMA 125. Further, since the host controller 120 can perform switching of these communications without replacing the input/output buffers, the switching of these communications can be executed at high speed. Similarly for the ports 230 to 232 provided in the memory device 2, the device controller 200 can execute switching of the communications at high speed.

Accordingly, the information processing device includes three types of ports, namely the first ports (referred to also as CPort 0) 130 and 230, the second ports (referred to also as CPort 1) 131 and 231, and the third ports (referred to also as CPort 2) 132 and 232.

Basically the first ports 130 and 230 are used only upon when a request is made from the host device 1 to the memory device 2. The second ports 131 and 231 and the third ports 132 and 232 are used upon when the memory device 2 sends the management information and the like to the host device 1.

<Write Operation>

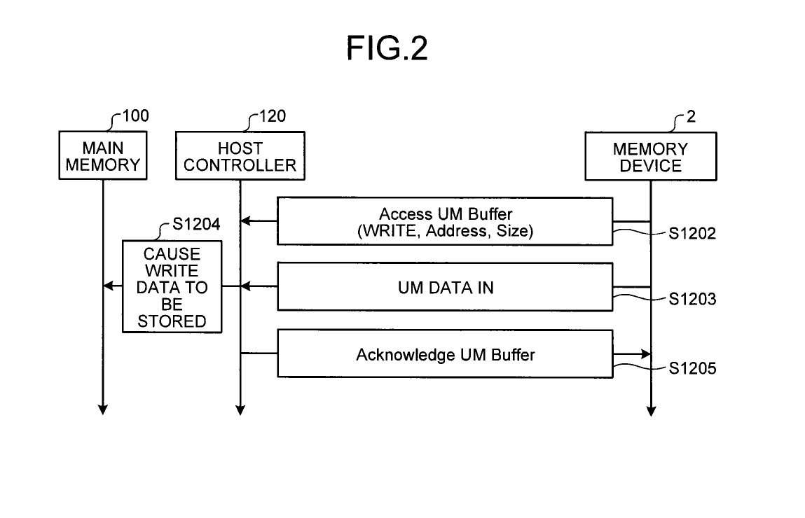

Next, by using FIG. 2, an operation example of the information processing device in the case of the memory device 2 sending the management information to the host device 1. FIG. 2 is a diagram illustrating an operation of the memory device 2 sending the management information to the host device 1.

The host device 1 notifies the memory device 2 in advance of a request designating a type of the management information that is desired to be acquired from the memory device 2 (management information acquiring request). The management information acquiring request is stored in the RAM 203 and the like. The management information acquiring request includes information such as an instruction to start the acquisition of the management information, a data range (address) of which acquisition is requested as the management information, and time interval by which the management information is to be acquired and the like.

[Step S1202]

The device controller main unit 202 of the memory device 2 generates a command to write the management information to the device-use domain 102 (Access UM Buffer) based on the management information acquiring request.

The Access UM Buffer includes “a write command, an address to which the management information is to be written, and data size of the management information” (WRITE, Address, Size) and the like, and information such as ports to be used upon sending the management information. The host device 1 stores a head address of the device-use domain 102 in the main memory 100. The address included in the Access UM Buffer is for example information indicating an offset position from the head address. The offset position can be a value that is equal to or more than a value obtained by adding the offset address (Address) and the data size (Size) set in a previous Access UM Buffer.

Each time the management information is sent, the device controller main unit 202 generates an Access UM Buffer that incremented the offset. Due to this, an address by which the management information at the time of the sending does not overwrite the management information that had previously been written but is written in the device-use domain 102 sequentially in order is set. The management information changes as time passes in accordance with the operation of the memory device 2. In the information processing device, the change in the management information by the operation of the memory device 2 can be observed by orderly writing the management information while incrementing the address.

[Step S1203]

Thereafter, the device controller main unit 202 sends management information corresponding to the management information acquiring request (UM DATA IN) to the host controller 120. When the command to write data (Access UM Buffer) is received from the memory device 2, the host controller 120 receives the write data (UM DATA IN) from the memory device 2 based on the information such as WRITE, Address, and Size.

Accordingly, in the information processing device, the memory device 2 spontaneously transfers the Access UM Buffer and UM DATA IN (management information) to the host device 1 without receiving a command string of the management information data transfer from the host device 1 side. Accordingly, in the information processing device, the management information can be transferred to the host device 1 from the memory device 2 side without depending on the command from the host device 1 side.

[Step S1204]

The host controller 120 causes the write data (management information) received from the memory device 2 to be stored in the device-use domain 102. Since the offset (address) is set in the Address of the Access UM Buffer for each of management information, the management information is addingly recorded in the device-use domain 102 in order.

[Step S1205]

When the write data is stored in the device-use domain 102, the host controller 120 sends a notifying command indicating that the write has been completed (Acknowledge UM Buffer) to the memory device 2. Due to this, the memory device 2 completes the data writing to the host device 1.

Notably, information for identifying the management information may be added to the Access UM Buffer and the UM DATA IN. In this case, the host device 1 distinguishes the user data (normal data 62 to be described later) and the management information sent from the memory device 2 based on identification information added to the Access UM Buffer and the UM DATA IN and stores the same in the main memory 100.

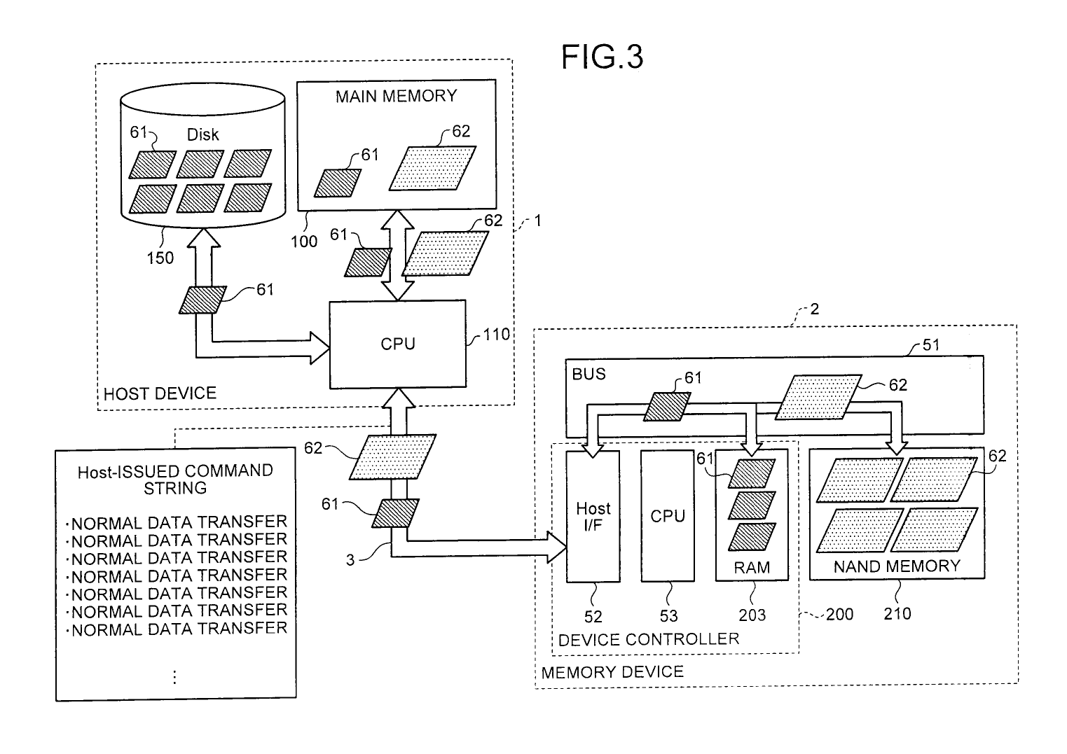

FIG. 3 is a diagram for explaining a write process of the management information and normal data from the memory device to the host device. Notably, depiction of the host controller 120 is herein omitted.

The normal data 62 is data (video data and the like) that the host controller 120 causes the memory device 2 to store. The management information 61 is information for debugging as described above.

In the information processing device the host device 1 sends a command that requests transfer of the normal data 62 (command requesting normal data transfer) to the memory device 2. Due to this, the memory device 2 sends the normal data 62 to the host device 1 via the communication path 3.

In the memory device 2 illustrated in FIG. 3 indicates a case in which the device controller 200 and the NAND memory 210 by a BUS 51. The device controller 200 includes a Host I/F 52, a CPU 53, and the RAM 203. The CPU 53 herein corresponds to the device controller main unit 202 illustrated in FIG. 1, and the Host I/F 52 herein corresponds to the host connecting adapter 201 illustrated in FIG. 1. Notably, in FIG. 3, depiction of the NAND connecting adapter 204 is omitted.

The memory device 2 stores the normal data 62 in the NAND memory 210. Further, when the CPU 53 of the memory device 2 receives the command for normal data transfer from the host device 1 (CPU 110), the CPU 53 reads the normal data 62 with the address corresponding to the command. The normal data 62 read by the CPU 53 is sent to the Host I/F 52 via the BUS 51, and is further sent to the host device 1 via the communication path 3. Due to this, the host device 1 stores the normal data 62 in the host-use domain 101 of the main memory 100.

Further, the memory device 2 stores the management information 61 in the RAM 203. The memory device 2 of the embodiment actively sends the management information 61 to the host device 1 without receiving the data transfer command from the host device 1. Among the management information 61, the information for debugging, the measurement result of performance, the error correction history and the like does not have to be returned to the memory device 2 after the memory device 2 had written the same in the host device 1. Due to this, the management information 61 in the memory device 2 may be directed in one-way manner from the memory device 2 to the host device 1, and the management information 61 in the host device 1 does not have to be overwritten (restored) in the memory device 2. In other words, the management information 61 is sent from the memory device 2 to the host device 1, but does not have to be sent from the host device 1 to the memory device 2.

Further, the management information 61 is updated in the memory device 2, and is additionally recorded in the host device 1 (host-side storage device) without being updated.

In the embodiment, although the command for requesting the normal data transfer is sent each time the host device 1 requests the normal data transfer, the command for requesting the management information transfer is not sent every time the transfer of the management information 61 is requested. The host device 1 only needs to send the transfer request for the management information 61 just once to the memory device 2 in advance. Due to this, the memory device 2 repeats management information sending process for plural times without receiving the instruction (observation command) to cause the management information 61 to be sent from the host device 1 each time the process to send the management information 61 to the host device 1 (management information sending process) takes place. In other words, the host device 1 causes the memory device 2 to repeat the management information sending process for plural times by sending the observation command (acquiring request for the management information) once.

In a case of sending the command for requesting the management information transfer each time the transfer of the management information 61 is requested, the command for management information transfer is inserted to the command string of the normal data transfer. In this case, since there are cases in which a processing state in the memory device 2 is disturbed, thus there is a case in which an error mode generated upon when the command for the management information transfer is not inserted is not found.

For example, in the information processing device, there is a case in which a garbage collection that generates one large storage domain by collecting a plurality of small and vacant storage domains is performed. In such a case, if the command for the management information transfer is inserted in the command string for the normal data transfer, there is a case in which the state of the memory device 2 changes each time the command for the management information transfer is sent. Under such a circumstance, the host device 1 may in some cases be unable to correctly find the error mode.

On the other hand, in the embodiment, the command string that the host device 1 issues to the memory device 2 is a command string requesting the normal data transfer. Thus, the host device 1 becomes capable of correctly finding the error mode even in the case of the garbage collection.

Accordingly, in the embodiment, the memory device 2 supports the Unified Memory Extension. Further, the memory device 2 transfers the management information 61 from its inside to the main memory 100 of the host device 1 by a validating process from the host device 1 (management information acquiring request). Due to this, the host device 1 saves the management information 61 from the memory device 2 in the main memory 100. Moreover, when the management information 61 cannot be stored in the device-use domain 102 any more, the host device 1 saves them orderly in the Disk 150 from the older management information 61, and secures vacant domains in the device-use domain 102. Due to this, the host device 1 stores the management information 61 as a state history of the memory device 2.

Accordingly, in the information processing device, the management information 61 can be observed in the host device 1 while suppressing load caused by command processes in the memory device 2. Accordingly, the host device 1 can analyze internal processes of the memory device 2 without disturbing the processing state within the memory device 2. Further, the host device 1 performs debugging of the memory device 2 by using the management information 61. Moreover, the host device 1 analyzes the state of the memory device 2 by using the management information 61.

Meanwhile, there is a method of using low-speed observation ports as a transmission path for inputting an observation command and a transmission path for outputting the management information 61. In this method, since transfer speed of the observation port is slow, neither an information transfer amount nor a transfer frequency of the management information 61 can be increased.

Alternately, there is a method that uses a normal data transfer port, and that issues the observation command each time the management information 61 is acquired. In this method, since the observation command is sent to the memory device as a part of a normal command process, the internal command processes of the memory device is disturbed.

On the other hand, in the embodiment, the observation command and the management information 61 are sent by using the normal data transfer ports. Further, the host device 1 does not issue the observation command each time the transfer of the management information 61 is requested. Accordingly, in the embodiment, it becomes possible to increase both the information transfer amount and the transfer frequency of the management information 61 without disturbing the flow of the command processes in the memory device 2.

Notably, in the above-described embodiment, although the description was given using the UFS memory device, adaptation can be made to other memory cards, memory devices, or internal memories and the like so long as they are semiconductor storage devices that operate similarly, and workings and effects similar to the above-described embodiment can be achieved. Further, the above-described NAND memory 210 is not limited to the NAND type flash memory, but may be other semiconductor memories.

As above, according to the embodiment, it becomes possible to observe the management information 61 from outside the memory device 2 while suppressing the load applied on the memory device 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device connected to a host device including a host-side storage device, the memory device comprising:
a non-volatile storage device with which read and write of data is performed in accordance with a request from the host device;
a volatile storage device that stores information indicating a state of the memory device and to be observed by the host device as observation information; and
a controller that executes an observation information sending process of sending a write command, which is an instruction to write the observation information in the host-side storage device, and the observation information to the host device, wherein
the controller repeats the observation information sending process plural times for each incident of the observation information sending process without receiving an instruction to send the write command and the observation information from the host device.

2. The memory device according to claim 1, wherein the observation information is information that is updated in the volatile storage device.

3. The memory device according to claim 1, wherein the observation information is information that is addingly recorded in the host-side storage device without being updated.

4. The memory device according to claim 1, wherein the write command is an instruction to cause the observation information to be written in a storage domain allotted to a device other than the host device among the host-side storage device.

5. The memory device according to claim 1, wherein the observation information is information that is sent from the volatile storage device to the host device, and is not sent from the host device to the volatile storage device.

6. The memory device according to claim 1, wherein the controller repeats the observation information sending process plural times when a validating process that is an acquiring request of the observation information is performed on the host device.

7. The memory device according to claim 1, wherein the acquiring request includes at least one of a data range of the observation information to be acquired, and a time interval by which the observation information is to be sent.

8. The memory device according to claim 1, wherein the observation information is one of:
information for managing a page within the non-volatile storage device, information for managing a block within the non-volatile storage device, information related to an error occurrence reported upon when data was read or written in the non-volatile storage device, information indicating a number of an error correction, information indicating a number of a retry operation that is performed in an event where the error correction is impossible, and state variables of a firmware disposed in a data domain.

9. The memory device according to claim 1, wherein the controller:
sets the write command with an offset position from a predetermined address within the host-side storage device in the observation information;
sends the write command with which the offset position is set to the host device; and
using a value, which is equal to or more than a value obtained by adding a first offset position set in a first write command that was sent in a previous sending and a data size of observation information that was sent in the previous sending, as a second offset position of a second write command that is to be sent after the first write command, so that the observation information that was sent in the previous sending is not updated within the host-side storage device.

10. An information processing device comprising:
a host device including a host-side storage device; and
a memory device connected to the host device, wherein the memory device includes:
a non-volatile storage device with which read and write of data is performed in accordance with a request from the host device;
a volatile storage device that stores information indicating a state of the memory device and to be observed by the host device as observation information; and
a first controller that executes an observation information sending process of sending a write command, which is an instruction to write the observation information in the host-side storage device, and the observation information to the host device, and that repeats the observation information sending process plural times for each incident of the observation information sending process without receiving an instruction from the host device to send the write command and the observation information; and
the host device includes a second controller that causes the observation information to be stored in the host-side storage device in a case where the write command and the observation information are sent from the memory device.

11. The information processing device according to claim 10, wherein the second controller addingly records the observation information in the host-side storage device without updating.

12. The information processing device according to claim 10, wherein the observation information is information that is updated in the volatile storage device.

13. The information processing device according to claim 10, wherein the observation information is information that is sent from the volatile storage device to the host device, and is not sent from the host device to the volatile storage device.

14. The information processing device according to claim 10, wherein
the first controller repeats the observation information sending process plural times when a validating process that is an acquiring request of the observation information is performed on the host device.

15. The information processing device according to claim 10, wherein the acquiring request includes at least one of a data range of the observation information to be acquired, and a time interval by which the observation information is to be sent.

16. The information processing device according to claim 10, wherein the observation information is one of:
information for managing a page within the non-volatile storage device, information for managing a block within the non-volatile storage device, information related to an error occurrence reported upon when data was read or written in the non-volatile storage device, information indicating a number of an error correction, information indicating a number of a retry operation that is performed in an event where the error correction is impossible, and state variables of a firmware disposed in a data domain.

17. The information processing device according to claim 10, wherein the first controller:
sets the write command with an offset position from a predetermined address within the host-side storage device in the observation information;
sends the write command with which the offset position is set to the host device; and
using a value, which is equal to or more than a value obtained by adding a first offset position set in a first write command that was sent in a previous sending and a data size of observation information that was sent in the previous sending, as a second offset position of a second write command that is to be sent after the first write command, so that the observation information that was sent in the previous sending is not updated within the host-side storage device.

18. An information processing method comprising:
a host device sending a send instruction to a memory device, the send instruction being for causing a write command, which is an instruction to write observation information in a host-side storage device and the observation information, the observation information indicating a state of the memory device and configured to be observed by the host device;
the host device writing the observation information in the host-side storage device when the memory device executes an observation information sending process of sending the write command and the observation information to the host device; and
the host device causing the memory device to repeat the observation information sending process plural times for each of the send instruction.

19. The information processing method according to claim 18, wherein the host device performs debugging of the memory device by using the observation information.

20. The information processing method according to claim 18, wherein the host device analyzes a state of the memory device by using the observation information.
